(19) United States
(12) Patent Application Publication
(10) Pub. No.: US 2009/0015857 A1
(43) Pub. Date: Jan. 15, 2009

(54) IMAGE FORMING APPARATUS, IMAGE FORMING METHOD, AND COMPUTER READABLE MEDIUM STORING PROGRAM

(75) Inventor: Yoko TSURUMI, Ebina-shi (JP)

Correspondence Address: SUGHRUE MION, PLLC, 2100 PENNSYLVANIA AVENUE, N.W., SUITE 800, WASHINGTON, DC, 20037, US

(73) Assignee: Fuji Xerox Co., Ltd., Tokyo (JP)

(21) Appl. No.: 11/944,037

(22) Filed: Nov. 21, 2007

(30) Foreign Application Priority Data
Jul. 11, 2007 (JP) 2007-181774

(51) Int. Cl. G06K 9/00

(52) U.S. Cl. 358/1.14

(57) ABSTRACT

An image forming apparatus includes: a display that displays a normal operational screen and information other than the normal operational screen; a personal information acquiring unit that acquires personal information of a user from his or her identification information stored on a storage medium; and a controller that controls post-processing based on the personal information acquired by the personal information acquiring unit and the information other than the normal operational screen to be displayed by the display.

### CROSS-REFERENCE TO RELATED APPLICATIONS

This application is based on and claims priority under 35 USC 119 from Japanese Patent Application No. 2007-181774 filed Jul. 11, 2007.

### BACKGROUND

1. Technical Field

The present invention relates to an image forming apparatus that displays information other than a normal operational screen, an image forming method, and a computer readable medium storing a program.

2. Related Art

Recently, image forming apparatus such as copiers and printers is installed not only at offices, but also in public places where general public often come in, such as convenience stores, libraries, and city halls. A display attached to the image forming apparatus to display an operational screen becomes larger. Consequently, some image forming apparatuses become capable of displaying information other than a normal operational screen on its display to make effective use of the display.

### SUMMARY

According to an aspect of the invention, there is provided an image forming apparatus including: a display that displays a normal operational screen and information other than the normal operational screen; a personal information acquiring unit that acquires personal information of a user from his or her identification information stored on a storage medium; and a controller that controls post-processing based on the personal information acquired by the personal information acquiring unit and the information other than the normal operational screen to be displayed by the display.

### BRIEF DESCRIPTION OF THE DRAWINGS

An exemplary embodiment of the present invention will be described in detail based on the following figures, wherein:

FIG. 1 illustrates a framework of an image processing system 1 relevant to an exemplary embodiment of the invention;

FIG. 2 is an enlarged outside view of an image forming apparatus 10 of the present exemplary embodiment;

FIG. 3 depicts a hardware structure of the image forming apparatus 10 of the present exemplary embodiment;

FIG. 4 is a block diagram depicting an arrangement of functions of the image forming apparatus 10, which are realized by executing an image processing program;

FIG. 5 illustrates a distribution destination list of advertising information, which is registered on an advertising information distribution server 30;

FIG. 6 illustrates authentication data registered on an authentication server 80;

FIG. 7 is a flowchart illustrating an advertising information acquisition process (S10) which is performed by the image forming apparatus 10 according to the present exemplary embodiment;

FIG. 8 is a flowchart of a screen switch control process (S20) for switching between an operational screen and an advertising information screen, which is performed by the image forming apparatus 10 according to the exemplary embodiment of the invention;

FIGS. 9A to 9D illustrate examples of advertising information provided by an advertising information providing server 60 and displayed or printed by the image forming apparatus 10; and

FIGS. 10A to 10D illustrate examples of service information provided by a service information providing server 70 and displayed or printed by the image forming apparatus 10.

### DETAILED DESCRIPTION

An exemplary embodiment of the present invention is described in detail with reference to the drawings.

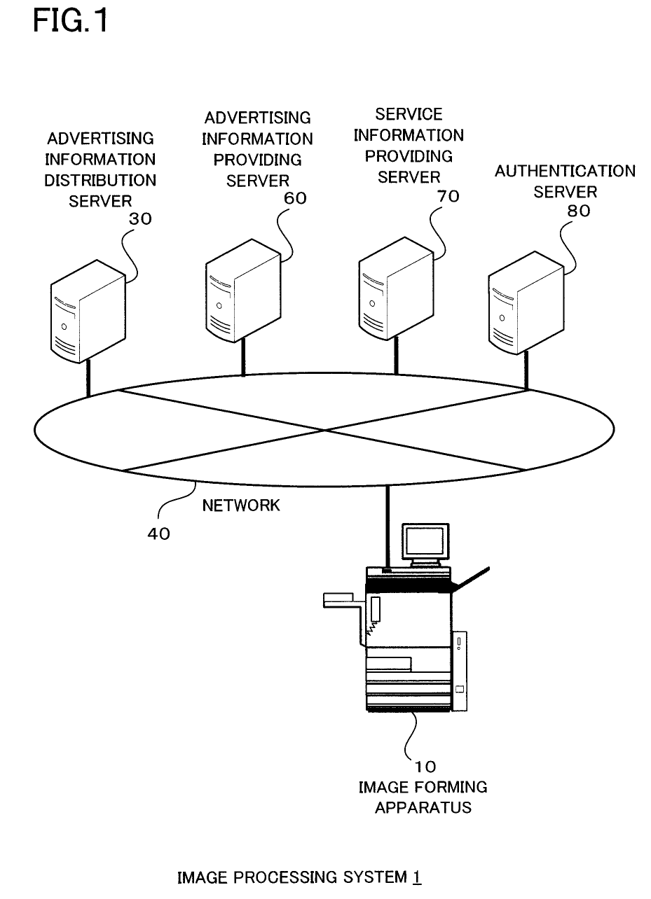

FIG. 1 illustrates a framework of an image processing system 1 relevant to an exemplary embodiment of the invention.

As shown in FIG. 1, the image processing system of the present exemplary embodiment includes an image forming apparatus 10, an advertising information distribution server 30, an advertising information providing server 60, a service information providing server 70, and an authentication server 80, linked via a network 40 such as a Local Area Network (LAN) or a Wide Area Network (WAN).

The image forming apparatus 10 is a complex machine having a printing function, a copying function, a facsimile transmitting/receiving function, and a scanning function. The advertising information distribution server 30 stores a variety of advertising information to be presented on a display of the image forming apparatus 10 and distributes advertising information to the image forming apparatus 10 according to a prearranged procedure.

In the present exemplary embodiment, the invention is explained for a situation where advertising information is used as information other than a normal operational screen. Alternatively, the invention can be applied in the same way for other situations where information other than advertising information, such as information about train situation, nearby sightseeing information, and event information is displayed as information other than the operational screen on the display of the image forming apparatus 10.

The advertising information providing server 60 and the service information providing server 70 are servers that provide web sites from where information to be distributed is available. The authentication server 80 stores the identifiers (IDs) of users and additional information associated with the IDs and authenticates each user.

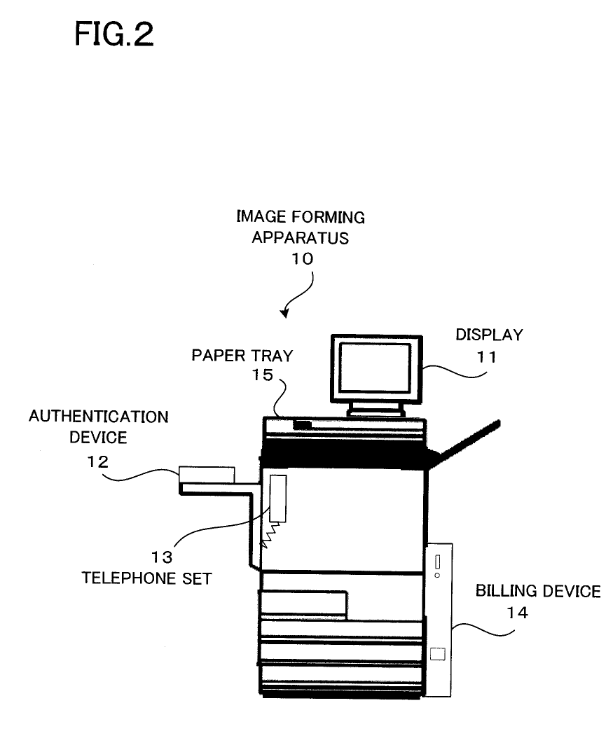

FIG. 2 is an enlarged outside view of the image forming apparatus 10 of the present exemplary embodiment.

As shown in FIG. 2, the image forming apparatus 10 of the present exemplary embodiment includes a display 11 for displaying a normal operational screen and advertising information, an authentication device 12, a telephone set 13, a billing device 14, and a paper tray 15.

The authentication device 12 reads identification information such as the ID of a user from a storage medium on which such information has already been stored, for example, such as a contactless IC card. Based on the identification information read by this device, it is possible to bill the user for using this apparatus. The telephone set 13 is linked to a public telephone line and can be used as an ordinary telephone. When the facsimile function of the image forming apparatus 10 is used, the user may first make a call to a destination over the telephone line, using the telephone set 13, and, after making sure of the connection to the destination, send facsimile data.

The billing device 14 is a device for billing a user who uses the apparatus without authentication for using the image forming apparatus 10. The billing device 14 is arranged to allow a user who paid a fee by slotting in a coin to use the image forming apparatus 10 to a limit set for the fee paid. Because of provision of this billing device 14, the functions of the image forming apparatus 10 are also available to a user who does not have a card for authentication.

The paper tray 15 is a tray to set an original to be copied, a page to be scanned by a scanner, or a page to fax in it.

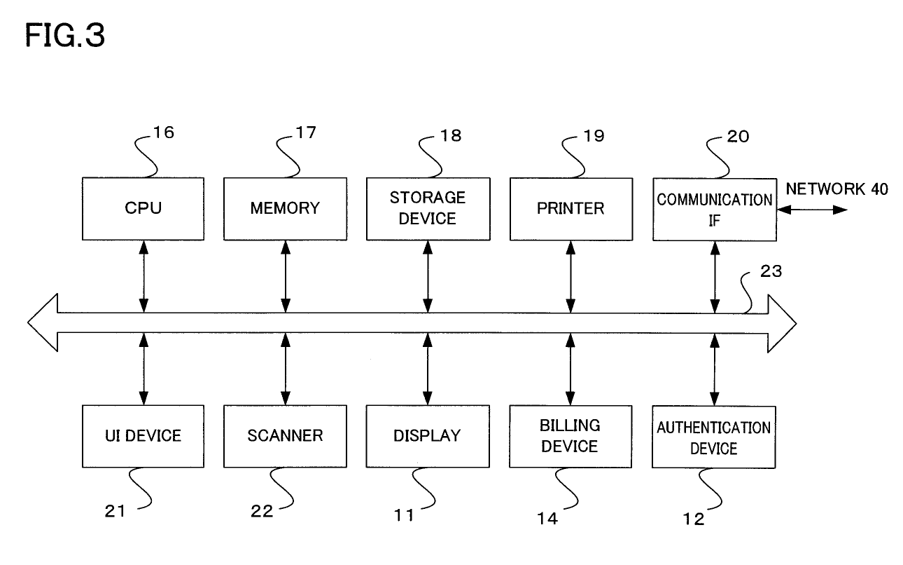

FIG. 3 depicts a hardware structure of the image forming apparatus 10 of the present exemplary embodiment.

As shown in FIG. 3, the image forming apparatus 10 includes a CPU 16, a memory 17, a storage device 18 such as a hard disk drive (HDD), a printer 19 which performs printing on a recording medium such as paper, a communication interface (IF) 20 which transmits and receives data to/from a remote machine such as an advertising information distribution server 30 or the like via the network 40, a user interface (UI) device 21 including a touch panel, manual operation buttons or indicator lamps, and the like, a scanner 22, a display 11, a billing device 14, and an authentication device 12. These components are interconnected via a control bus 23.

The CPU 16 executes predetermined processing based on an image processing program stored in the memory 17 or the storage device 18 and controls the operation of the image forming apparatus 10. The advertising information distribution server 30, the advertising information providing server 60, the service information providing server 70, and the authentication server 80 also have the hardware structure including the CPU 16, memory 17, storage device 18, communication IF 20, and other components, which make these servers operable as the computers that perform data communication via the network.

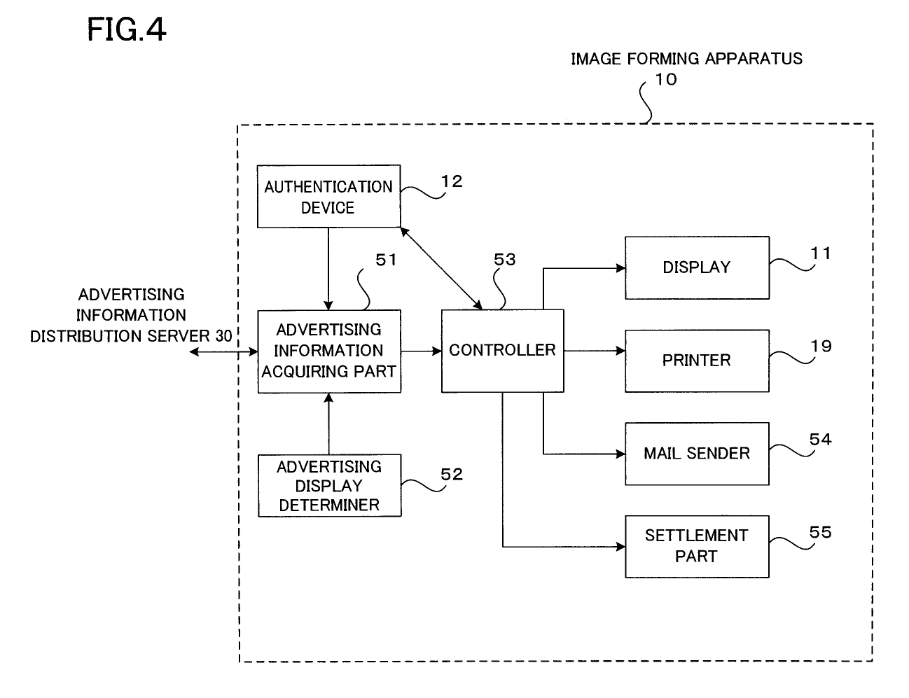

FIG. 4 is a block diagram depicting an arrangement of functions of the image forming apparatus 10, which are realized by executing the image processing program.

As shown in FIG. 4, the image forming apparatus 10 is provided with an advertising information acquiring part 51, an advertising display determiner 52, a controller 53, a mail sender 54, a settlement part 55, the display 11, the authentication device 12, and the printer 19.

The controller 53 controls these components and sends/receives data to/from the components. Also, by use of application software such as a Web browser, the controller 53 generates image data for a normal operational screen to display and image data for advertising information to display, acquired by the advertising information acquiring part 51, and sends the image data to the display 11 to display it.

Furthermore, the controller 53 controls post-processing based on personal information acquired by the authentication device 12 and information other than the operational screen to be displayed by the display 11. More specifically, the controller 53 controls the information to be displayed such that the personal information acquired by the authentication device 12 is included in the advertising information to be displayed by the display 11. Moreover, using the acquired personal information, the controller 53 controls printing, mail transmission, and fax transmission of information relevant to the advertising information.

The advertising information acquiring part 51 acquires advertising information distributed from the advertising information distribution server 30 via the network 40. The advertising information acquiring part 51 acquires advertising information, triggered by receiving a signal to acquire advertising information output from the advertising display determiner 52 which will be described later. Advertising information is in at least one of HTML (HyperText Markup Language) form, XML (Extensible Markup Language) form, and image file, and stored in the storage device 18 of the advertising information distribution server 30. Distributing advertising information will be detailed later.

The advertising display determiner 52 determines whether a period during which there is no user action exceeds a predetermined period which has been set beforehand. If the no action period has exceeded the predetermined period, the advertising display determiner 52 outputs a signal to acquire advertising information to the advertising information acquiring part 51.

The mail sender 54 sends an e-mail message including information controlled by the controller 53 to an e-mail address included in personal information acquired by the authentication device 12.

The settlement part 55 performs a settlement procedure for payment by the user for advertising or service, based on the personal information acquired by the authentication device 12. More specifically, the settlement part 55 is realized in a form that is executable from Web content displayed on the Web browser. For example, the settlement part 55 is a Common Gateway Interface (CGI) that is executed by Http request for a local address. The settlement procedure will be detailed later.

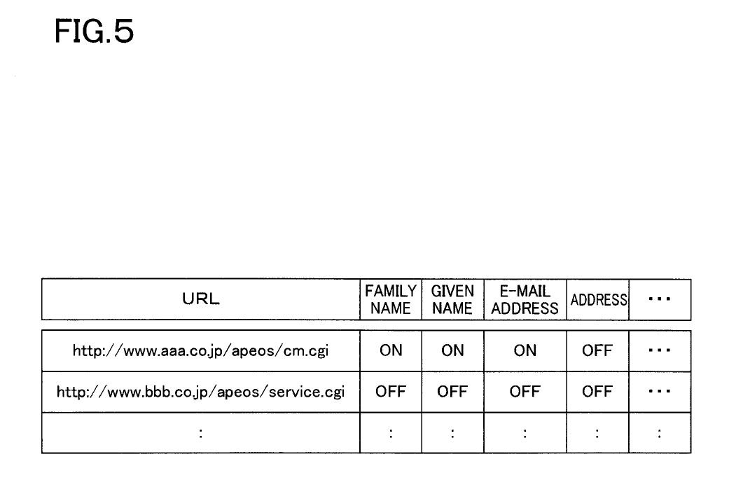

FIG. 5 illustrates a distribution destination list of advertising information, which is registered on the advertising information distribution server 30.

As shown in FIG. 5, the URLs of sites existing on the Internet are registered in the distribution destination list. In the image processing system 1, as examples of such sites, the advertising information providing server 60 and the service information providing server 70 are included.

Hence, the advertising information distribution server 30 transmits advertising information provided by the advertising information providing server 60 included in the distribution destination list and a service provided by the service information providing server 70 to the image forming apparatus 10. Then, such information or service is displayed on the display 11 of the image forming apparatus 10. If plural sites are registered in the distribution destination list, each of advertising information or the like is displayed for a given period of time and cyclically. If no site is registered in the distribution destination list, the advertising information distribution server 30 transmits predetermined information which has been set beforehand to the image forming apparatus 10 and this information is displayed.

Moreover, in the distribution destination list, personal information that is transmitted from the advertising information distribution server 30 to the distribution destinations such as the advertising information providing server 60 is registered. The personal information to be transmitted is, for example, a set of name, e-mail address, address, etc. For each of these attributes, either On or Off is set. If On is set for an attribute, the content of the attribute is transmitted from the advertising information distribution server 30 to the advertising information providing server 60 and the like.

The advertising information distribution server 30 transmits personal information received from the image forming apparatus 10 to the advertising information providing server 60 and the like by use of a method; for example, using an extension field in an Http header or generating a POST request and embedding that information as data in the POST request. Hence, the advertising information providing server 60 or the like receives personal information, the advertising information providing server 60 or the like incorporates the received personal information into advertising information or the like and transmits the advertising information or the like including the personal information to the advertising information distribution server 30.

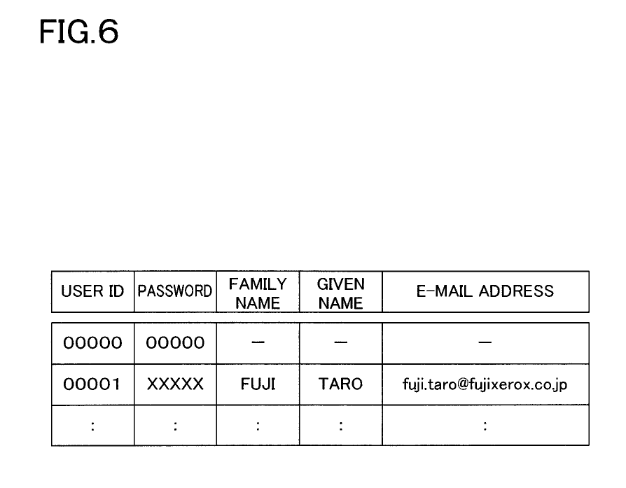

FIG. 6 illustrates authentication data registered on the authentication server 80.

As shown in FIG. 6, authentication data includes attributes such as user ID, password, name, and e-mail address. An authentication procedure is executed by the authentication server 80, based on a user ID and a password transmitted by the advertising information distribution server 30. Hence, when the image forming apparatus 10 transmits a user ID and a password to the advertising information distribution server 30, the advertising information distribution server 30 performs personal authentication via the authentication server 80 based on the received user ID and password and transmits a result of the authentication to the image forming apparatus 10.

Authentication data held on the authentication server 80 includes data for guest user (with a user ID of 00000 and a password of 00000 in this example) and data for individual user (with a user ID of 00001 or subsequent in this example). Hence, when user ID and password corresponding to the data for guest user are transmitted, the user is authenticated as a guest user. Attributes included in personal data are not limited to those mentioned in this example and other attributes may be included in personal data.

Then, the operation of the image forming apparatus 10 of the present exemplary embodiment is described in detail with reference to the relevant drawing.

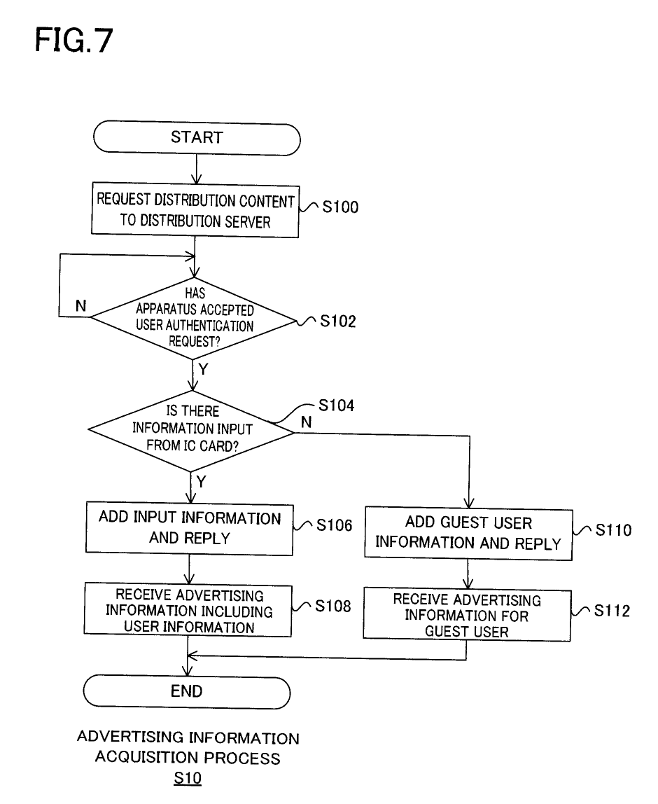

FIG. 7 is a flowchart illustrating an advertising information acquisition process (S10) which is performed by the image forming apparatus 10 according to the present exemplary embodiment.

As shown in FIG. 7, at step 100 (S100), the advertising information acquiring part 51 of the image forming apparatus 10 requests advertising information to the advertising information distribution server 30. For example, the advertising information acquiring part 51 transmits an HTTP request.

When the advertising information distribution server 30 receives the request for advertising information, it requests user authentication information to the image forming apparatus 10. For example, the advertising information distribution server 30 returns a 401Unauthorized response to the request.

At step 102 (S102), the advertising information acquiring part 51 determines whether the apparatus has accepted a user authentication request transmitted from the advertising information distribution server 30. If the apparatus has accepted the user authentication request, the advertising information acquiring part 51 goes to step S104; otherwise, it returns to step S102.

At step 104 (S104), the advertising information acquiring part 51 determines whether there is personal information acquired from an IC card or the like by the authentication device 12. If there is personal information, the advertising information acquiring part 51 goes to step S106; otherwise, it goes to step S110.

At step 106 (S106), the advertising information acquiring part 51 transmits the acquired personal information to the advertising information distribution server 30. For example, the advertising information acquiring part 51 adds the acquired user ID and password in an Authorization header and transmits the request again to the advertising information distribution server 30.

Upon receiving the user ID and password, the advertising information distribution server 30 performs authentication via the authentication server 80. Once the user ID and password are authenticated, the advertising information distribution server 30 transmits the personal information (e.g., name and others) which has been received from the image forming apparatus 10 to the advertising information providing server 60 that provides advertising information to be distributed. The advertising information providing server 60 embeds the personal information received into advertising information and transmits the advertising information including the personal information to the advertising information distribution server 30. The advertising information distribution server 30 distributes the advertising information to the image forming apparatus 10.

At step 108 (S108), the advertising information acquiring part 51 receives the advertising information including the personal information, created as above.

On the other hand, at step 110 (S110), the advertising information acquiring part 51 transmits the user ID and password for guest user, which have been set beforehand, to the advertising information distribution server 30. In a case where the personal information transmitted at step S106 is not authenticated, the advertising information acquiring part 51 transmits the information for guest user as well.

Upon accepting the user ID and password for guest user, the advertising information distribution server 30 performs authentication of the guest user via the authentication server 80. When the guest user is authenticated, the advertising information distribution server 30 transmits null data for personal information to the advertising information providing server 60 that provides advertising information to be distributed. The advertising information providing server 60 transmits either advertising information in which the space allocated for personal information is empty or advertising information for guest user to the advertising information distribution server 30. The advertising information distribution server 30 distributes the advertising information to the image forming apparatus 10.

At step 112 (S112), the advertising information acquiring part 51 receives advertising information for guest user, created as above.

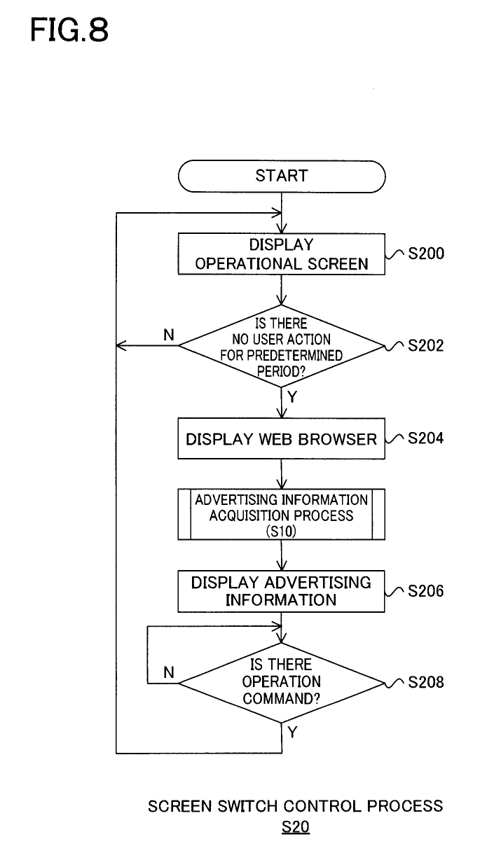

FIG. 8 is a flowchart of a screen switch control process (S20) for switching between an operational screen and an advertising information screen, which is performed by the image forming apparatus 10 according to the exemplary embodiment of the invention.

As shown in FIG. 8, at step 200 (S200), the controller 53 of the image forming apparatus 10 displays a normal operational screen on the display 11.

At step 202 (S202), the advertising display determiner 52 determines whether a predetermined period has elapsed, while no user action occurs. If no user action occurs for the predetermined period, the advertising display determiner 52 goes to step S204; if user action occurs before the elapse of the predetermined period, the image forming apparatus 10 returns to step S200.

At step 204 (S204), the controller 53 displays a Web browser on the display 11. At the same time, the advertising display determiner 52 outputs a notification to acquire advertising information to the advertising information acquiring part 51. When the advertising information acquiring part 51 accepts the notification, the advertising information acquisition process (S10; FIG. 7) is executed.

At step 206 (S206), the controller 53 displays advertising information acquired by the advertising 5information acquiring unit 51 on the Web browser.

At step 208 (S208), the controller 53 determines whether an operation command such as, for example, copy, has been accepted via the UI device 21. If the operation command has been accepted, the controller 53 hides the Web browser, deactivates displaying advertising information, and returns to step S200. If there is no operation command accepted, the controller returns to step S208. In the latter case, advertising information remains displayed on the display 11.

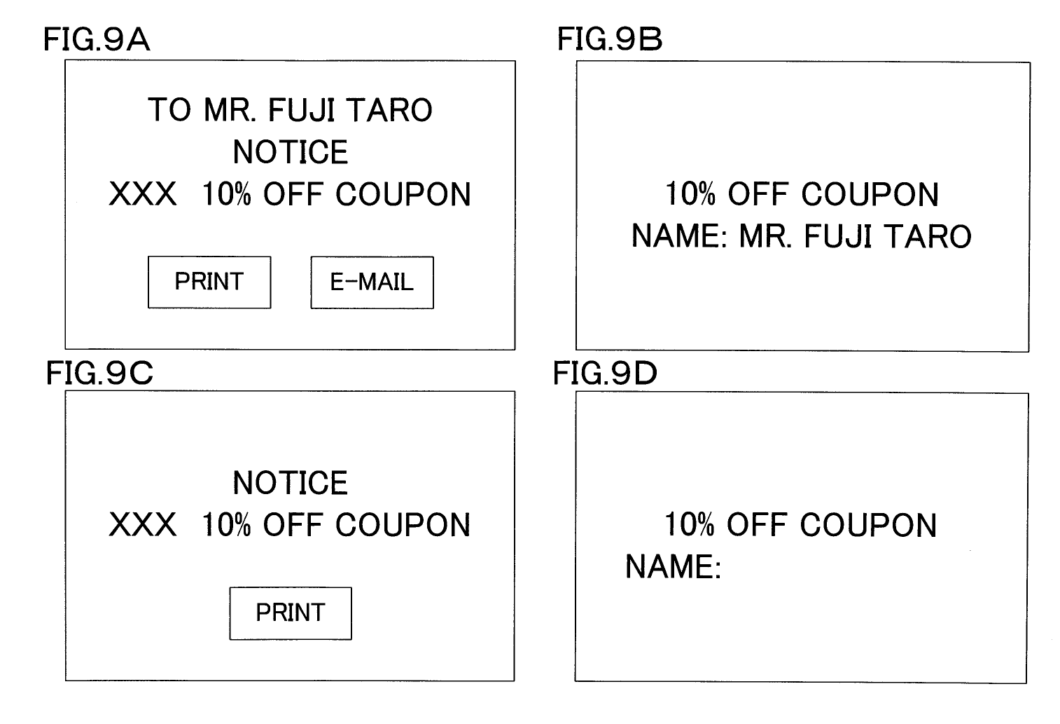

FIGS. 9A to 9D illustrate examples of advertising information provided by the advertising information providing server 60 and displayed or printed by the image forming apparatus 10.

FIG. 9A illustrates an example of advertising information that is distributed to a user whose personal information has been authenticated. As shown in FIG. 9A, the advertising information is a 10% off coupon ticket for goods and this advertising information includes the user name.

In the case where personal information has been authenticated, for example, a print button for submitting a print command and, for example, an e-mail button for submitting an e-mail transmit command are displayed on the screen. Accordingly, when the print button is pressed, the advertising information is printed. When the e-mail button is pressed, the advertising information is transmitted to an e-mail address included in the personal information. FIG. 9B illustrates a result of print output upon the pressing of the print button shown in FIG. 9A. As shown in FIG. 9B, the personal information is included in the printed advertising information.

FIG. 9C illustrates an example of advertising information that is distributed to a guest user and a user whose personal information has not been authenticated. As shown in FIG. 9C, no personal information is included in the advertising information. On the screen, the print button is displayed, whereas the e-mail button is not displayed. FIG. 9D illustrates a result of print output upon the pressing of the print button shown in FIG. 9C. As shown in FIG. 9D, no personal information is included in the printed advertising information. In this case, the space reserved for personal information is empty.

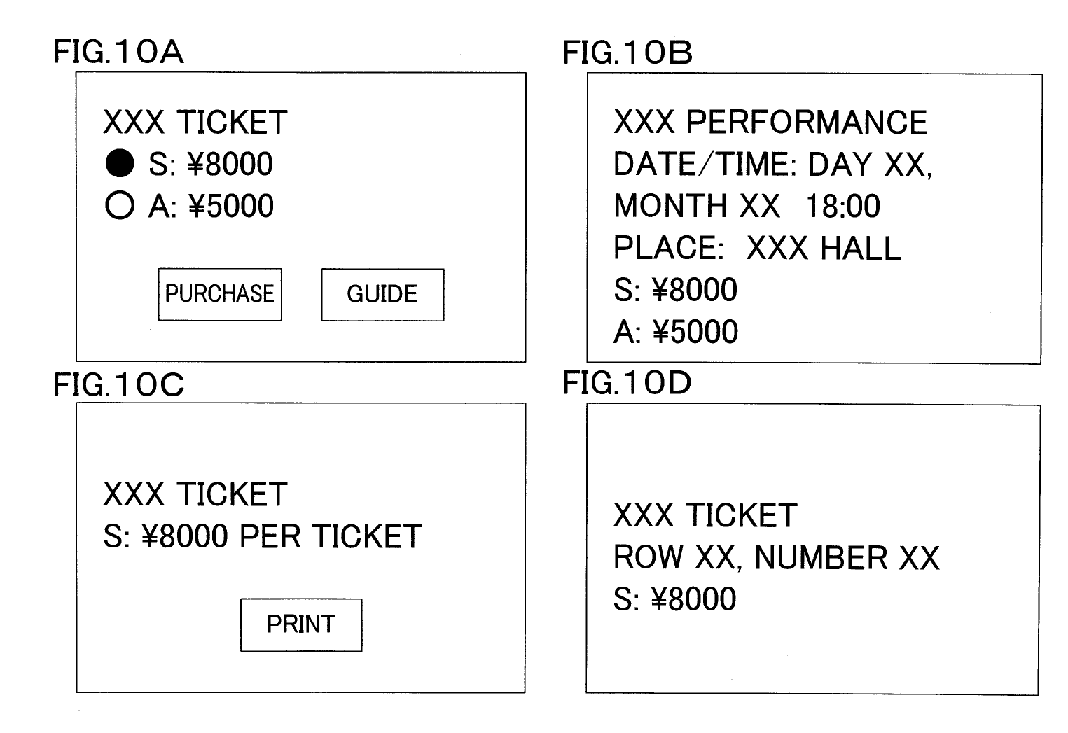

FIGS. 10A to 10D illustrate examples of service information provided by the service information providing server 70 and displayed or printed by the image forming apparatus 10.

FIG. 10A illustrates an example of service information that is distributed to a user whose personal information has been authenticated. As shown in FIG. 10A, the service information is sales information for a ticket of a performance. On the screen, a purchase button for submitting a purchase order of the ticket and a guide button for printing further detailed information are displayed. Ticket classes are also displayed with, for example, radio buttons allowing the user to choose.

FIG. 10B illustrates a result of print output upon the pressing of the guide button shown in FIG. 1A. FIG. 10C exemplifies a screen displayed upon the pressing of the purchase button shown in FIG. 10A. When the purchase button is pressed after a ticket class is chosen, as shown in FIG. 10C, the controller 53 of the image forming apparatus 10 controls the settlement part 55 to perform a settlement procedure for payment of the selected ticket, based on the personal information which has been acquired and authenticated.

FIG. 10D illustrates a result of print output upon the pressing of the print button shown in FIG. 10C. As shown in FIG. 10D, the ticket purchased is printed, once its settlement has been completed.

In a case where service information is distributed to either a guest user or a user whose personal information has not been authenticated, the purchase button in the screen shown in FIG. 10A is not displayed, but only the guide button is displayed. Thus, the user is allowed to merely view the service information on the display 11.

The present invention may be embodied in other specific forms without departing from its spirit or characteristics. The described exemplary embodiments are to be considered in all respects only as illustrated and not restrictive. The scope of the invention is, therefore, indicated by the appended claims rather than by the foregoing description. All changes which come within the meaning and range of equivalency of the claims are to be embraced within their scope.

What is claimed is:

1. An image forming apparatus comprising:
a display that displays a normal operational screen and information other than the normal operational screen;
a personal information acquiring unit that acquires personal information of a user from his or her identification information stored on a storage medium; and
a controller that controls post-processing based on the personal information acquired by the personal information acquiring unit and the information other than the normal operational screen to be displayed by the display.

2. The image forming apparatus according to claim 1, wherein the controller controls information to be displayed by the display such that the personal information acquired by the personal information acquiring unit is included in the information other than the normal operational screen to be displayed by the display.

3. The image forming apparatus according to claim 1, wherein the controller controls printing such that the personal information acquired by the personal information acquiring unit is included in information relevant to the information other than the normal operational screen to be displayed by the display.

4. The image forming apparatus according to claim 1, wherein the controller controls to transmit information relevant to the information other than the normal operational screen to be displayed by the display to an address included in the personal information acquired by the personal information acquiring unit.

5. The image forming apparatus according to claim 1,
wherein the display displays information relevant to at least one of advertising and service as the information other than the normal operational screen; and
the image forming apparatus further comprises a settlement unit that performs a settlement procedure for at least one of the advertising and service displayed by the display, using the identification information stored on the storage medium or the personal information acquired by the personal information acquiring unit.

6. The image forming apparatus according to claim 1, further comprising a medium reading unit that reads a magnetic storage medium having information stored thereon,
wherein the personal information acquiring unit acquires personal information based on information read by the medium reading unit.

7. An image forming method comprising:
acquiring personal information of a user from his or her identification information stored on a storage medium; and
controlling post-processing based on the personal information acquired and the information other than the normal operational screen to be displayed.

8. A computer readable medium storing a program causing a computer to execute a screen switch control method for switching between a normal operational screen and a screen to display information other than the normal operational screen, the program causing the computer to execute a process comprising:
acquiring personal information of a user from his or her identification information stored on a storage medium; and
controlling post-processing based on the personal information acquired and the information other than the normal operational screen to be displayed.
